(19) United States
(12) Patent Application Publication
(10) Pub. No.: US 2009/0006967 A1
(43) Pub. Date: Jan. 1, 2009

(54) LIVE COPY-PASTE

(75) Inventors: Jensen M. Harris, Kirkland, WA (US); Srikanth Shoroff, Sammamish, WA (US); Richard J. Wolf, Seattle, WA (US); Eran Mediggo, Bellevue, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/768,665

(22) Filed: Jun. 26, 2007

(51) Int. Cl. G06F 3/00

(52) U.S. Cl. 715/724

(57) ABSTRACT

Copying and pasting information from one application to another allows identical information to be present in multiple locations. Pasted information can be updated based on changes to the source of the pasted information. With updating pasted information, the information can remain identical in both locations even if a change takes place after the paste.

### TECHNICAL FIELD

The subject specification relates generally to computer applications and in particular to embedding real-time information into an application.

### BACKGROUND

Recent developments in computer applications allow individuals to operate programs with a high level of complexity. Computers can have multiple applications operating at the same time and a user can navigate between the applications at his leisure. Various user interfaces (e.g., keyboard, mouse, touch screen, stylus, etc.) allow users to navigate between different programs.

Word processing applications in particular have developed to allow users to create single files with large amounts of information. Classically, mechanical typewriters allow individuals to create formatted documents, as well as multiple copies of a formatted document (e.g., utilization of carbon paper.) Mechanical typewriters developed into word processing machines that were purpose specific machines to allow users to store text information as a document. Personal computers have the capability to run word processing programs that allow users to create relatively large documents.

Furthermore, multiple applications can integrate with a word processing application. For example, a word processing application can be designed to function with a spreadsheet application, a database application, an electronic mail application, and the like. A user can use multiple applications at one time in order to achieve one goal. For example, a user can utilize a spreadsheet to perform accounting functions and use a text document to compose a letter relating to the accounting results. One feature that allows multiple programs to function together is a copy-paste function.

A copy-paste function allows a user to transfer data from one location to another. This can be between like applications (e.g., from one word processing document to another) or between different applications (e.g., from a word processing document to a spreadsheet). To engage in a copy-paste, a user selects a copy command over information (e.g., text, a picture, etc.) A computer retains a replica and places the replica on a location signified by the user through the paste command. The copied text is pasted into a new location. For example, accounting information can transfer from a spreadsheet to a text document.

### SUMMARY

The following presents a simplified summary of the specification in order to provide a basic understanding of some aspects of the specification. This summary is not an extensive overview of the specification. It is intended to neither identify key or critical elements of the specification nor delineate the scope of the specification. Its sole purpose is to present some concepts of the specification in a simplified form as a prelude to the more detailed description that is presented later.

Conventional systems allow for the copying and pasting of information; however, these systems do not allow information to be updated automatically once the information has been pasted. The subject specification allows for a live copy-paste system where pasted information is updated based on changes in a source of pasted information. Live copy-paste allows an application to contain up-to-date information that can be of benefit to a system and/or user.

An embed component places information into an application (e.g., word processing document, spreadsheet, etc.) When placing the information into the application, context and properties of the placed information can be lost. These properties can be retained in storage and used at another time; placed information can inherit original context and properties of the application. An update component modifies placed information when a change takes place at the source. For example, if pasted information lists a price of an item and the source changes the price, then the update component changes the pasted information to reflect a source price change.

Various embodiments and features can be used to enhance the capabilities of the system disclosed in the subject specification. Operators can be charged a fee to utilize a live copy-paste or pasted information can be augmented with advertisement information. Furthermore, various checks can take place to assure that pasting according to the subject specification will not cause an error to a system. In addition, there can be a database of visualization tools that allow users to operate different aspects of the subject specification (e.g., tool to re-paste information in its original context.)

The following description and the annexed drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

FIG. 1 illustrates a representative system for manipulation of a live copy-paste in accordance with an aspect of the subject specification.

FIG. 2 illustrates a representative system for operation of a live copy-paste in accordance with an aspect of the subject specification.

FIG. 3 illustrates a representative system for creation of a live copy-paste with a feedback component in accordance with an aspect of the subject specification.

FIG. 4 illustrates a representative system for creation of a live copy-paste with an advertisement component in accordance with an aspect of the subject specification.

FIG. 5 illustrates a representative system for creation of a live copy-paste with a transformation component in accordance with an aspect of the subject specification.

FIG. 6a illustrates a first part of a representative methodology for operation of a live copy-paste in accordance with an aspect of the subject specification.

FIG. 6b illustrates a second part of a representative methodology for operation of a live copy-paste in accordance with an aspect of the subject specification.

FIG. 7 illustrates a representative methodology for performance of a live copy-paste in accordance with an aspect of the subject specification.

FIG. 8 illustrates an example of a schematic block diagram of a computing environment in accordance with the subject specification.

FIG. 9 illustrates an example of a block diagram of a computer operable to execute the disclosed architecture.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system”, “interface”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. As another example, an interface can include I/O components as well as associated processor, application, and/or API components.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

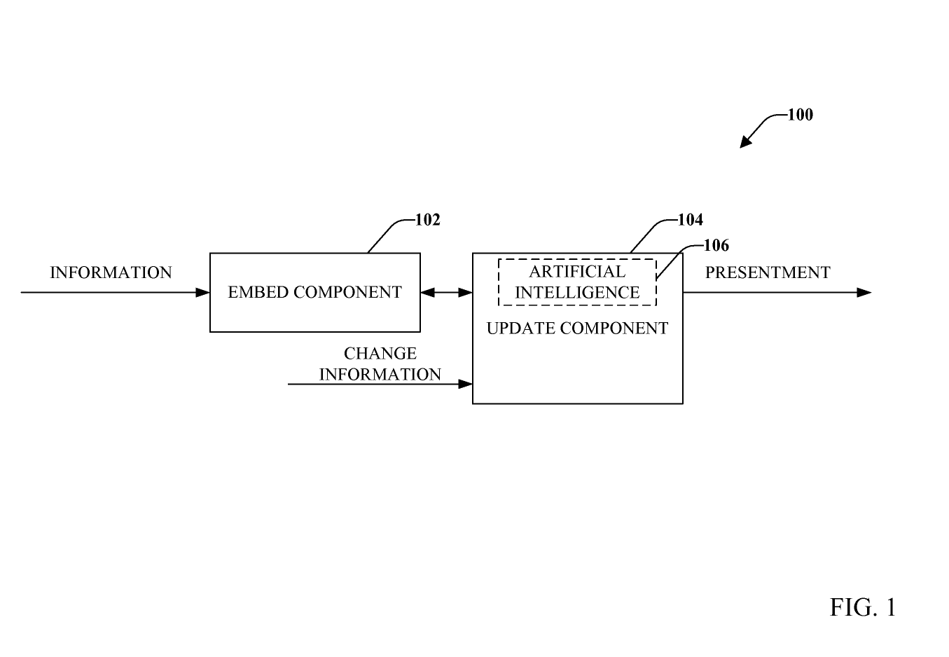

FIG. 1 discloses an example system 100 for updating pasted information into a computer application. Information travels to an embed component 102. The embed component 102 pastes information copied from an auxiliary source. For example, temperature information at a weather station can be pasted into a document by the embed component 102. The embed component 102 communicates with an update component 104 that data that could change from an auxiliary source has been pasted. According to another embodiment, the update component 104 makes a recognition that pasted data could change from an auxiliary source. An example of an auxiliary source is a remote source (e.g., an online source, a personal digital assistant, etc.) Furthermore, an auxiliary source can be a computer application separate from an application receiving a paste (e.g., a calculator is an auxiliary source while an application receiving a paste is an integrated word processing/spreadsheet application.)

The update component 104 receives change information and updates pasted information according to the change information. For example, if the pasted information is the temperature, then when the temperature changes, the pasted information in the document should also change. Therefore, the update component 104 can modify pasted information according to a relevant change. The update component 104 can operate manually (e.g., a user engages a refresh command) or automatically (e.g., information is updated at a set time without engagement by a user.)

The update component 104 can also configure to update information selectively based on internal logic. An optional learning and reasoning system, referred to as artificial intelligence 106, can be employed by the update component 104 in connection with making determinations or inferences regarding changing pasted information. Artificial intelligence 106 makes an inference and/or determination if a change should be made to pasted information. The artificial intelligence 106 can employ for example, a probabilistic-based or statistical-based approach in connection with making determinations or inferences. The inferences can be based in part upon explicit training of classifier(s) (not shown) before employing the system 100, or implicit training based at least upon a vehicle's, or user's previous actions, commands, instructions, and the like during use of the system. Artificial intelligence 106 can make an inference or determination if a change by the update component 104 would be detrimental (e.g., should a change take place, would a change harm the system 100, etc.)

Artificial intelligence 106 can employ one of numerous methodologies for learning from data and then drawing inferences from the models so constructed (e.g., Hidden Markov Models (HMMs) and related prototypical dependency models, more general probabilistic graphical models, such as Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches that perform data fusion, etc.) in accordance with implementing various automated aspects described herein.

For example, if the source of the information fails (e.g., the source looses power), then change information can reach the update component 104 showing the failure (e.g., the temperature changes from “300K” to “. . . . ”) However, it can be undesirable to display the change information of a failure. Therefore, the update component 104 can select not to implement the change information through utilization of the artificial intelligence 106.

In an example operation of the system 100, there can be placing of a stock symbol into a word processing document. Data that relates to the stock symbol can constantly change. For example, price, number of shares traded, and the like are continuously changing in real-time during stock exchange hours. A user can desire to place a real-time stock symbol in a word processing document. In doing so, it is likely the user does not want a static symbol (e.g., a symbol that displays data at a time of pasting), but a symbol that updates as related information updates. The user engages in a copy command and information with contextual information transfers to the embed component 302.

The embed component 102 can recognize data concerning the stock symbol copy. For example, there can be recognition that the stock symbol relates to a price that changes in real-time. The embed component 102 can place the stock symbol in an application and transfer a notice to the update component 104. The update component 104 identifies that information of the symbol could change and makes a record concerning the symbol. When the system receives change information, the update component 104 changes the stock symbol.

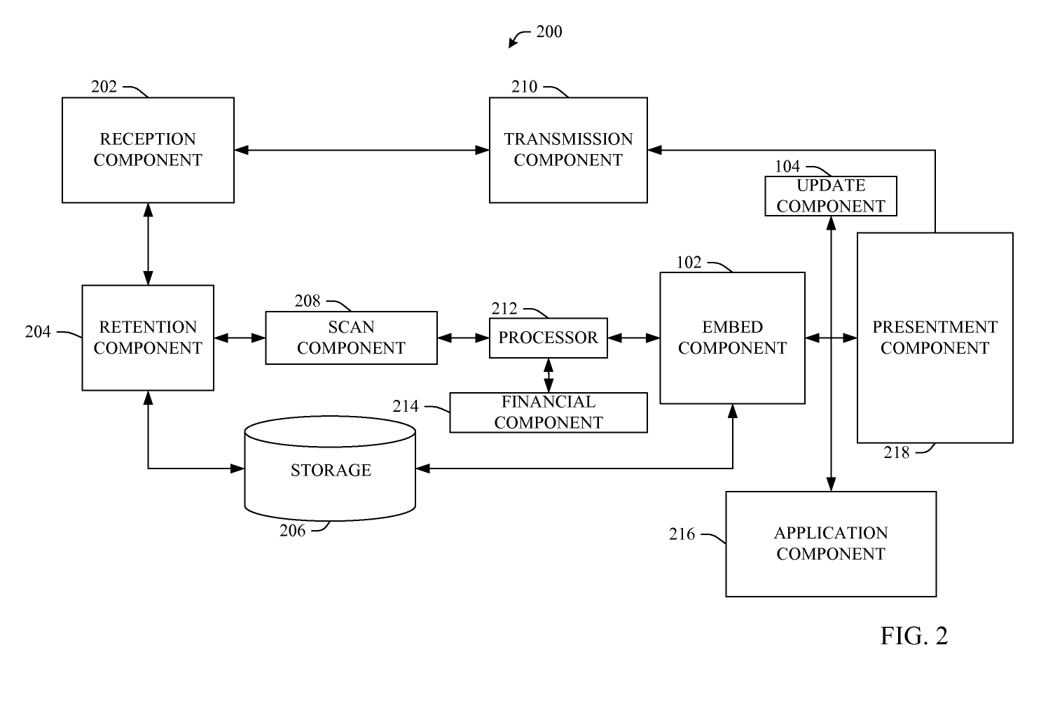

FIG. 2 discloses an example system 200 that encompasses the retention component 102 and the embed component 104. A reception component 202 can obtain information that relates to operation of the system 200. According to one embodiment, the reception component 202 gathers copied information and contextual data that is to be pasted into an application. The reception component can operate according to a number of different manners, including wirelessly and through a wired system.

A retention component 204 extracts contextual data from the copied information and makes a record of the information into storage 206. For example, copied data can contain information that relates to text font. The retention component 204 can recognize font data and store the data in storage 206. Furthermore, the retention component 204 can hold a log that contains information on the organization of the storage 206.

Storage 206 can configure according to a number of different embodiments. According to one embodiment, storage 206 is a common location that can be accessed by other components of the system 200. According to another embodiment, the storage 206 is dedicated to the retention component 204. According to yet a further embodiment, the storage can be removable. In another embodiment, the storage is at a remote location. Storage can be of various types of computer memory, including random access memory, read only memory, flash memory, and the like.

A scan component 208 can determine if there are any problems with copied information. Copied information can contain unwanted information and/or unwanted characteristics. For example, copied information can contain a virus that can cause damage to the system 200. The scan component 208 can identify a virus and block its passage to further components of the system. Furthermore, the scan component can utilize a transmission component 210 to send a notification that a virus was received and successfully stopped.

According to another embodiment, copied information can have incidental detrimental effects on the system 200. For example, the system can only paste information that is less then or equal to 100 kilobytes (KB); however, information to be pasted is 150 KB. Therefore, the system would not be able to complete a full live copy-paste. The scan component 208 can identify a problem and attempt to correct the problem. Continuing the previous example, the scan component 208 can compress information where applicable. The scan component 208 can utilize artificial intelligence similar to the intelligence 106 of FIG. 2 in making determinations and or inferences on how to handle perceived errors.

According to yet another embodiment, the scan component 208 can check if an update will cause any errors in the system. For example, an update can cause the consumption of more memory and/or more system 200 resources (e.g., pasted 4-bit information can be updated to 16-bit information that cannot be handled by the system 200.) The scan component 208 can identify a potential problem, attempt to correct the potential problem, and/or send notification that relates to the potential problem.

The transmission component 210 can operate in a wired or wireless capacity. Various components can utilize the capabilities of the transmission component 210. For example, in addition to the scan component 208, the reception component 202 can utilize the transmission component 210 to gather information, including what information is to be copied as well as related contextual data. Furthermore, the transmission component can be used to provide updates on system status (e.g., report malfunctioning components.)

A processor 212 can operate as the control unit of the system 200 and coordinate various components of the system 200. For example, the system 200 could be powered by a battery. Constant operation of all components can place a large drain on the battery and shortening both the batter span and likely the overall battery life. The processor 212 can regulate power consumption by turning components on when they need to operate and off when they are not in use.

The system 200 can utilize a financial component 214 in conjunction with live copy-paste. In order for the system to paste updatable information into an application, there could be a fee associated with the application. According to one embodiment, the system 200 could place a small charge for each time a paste is made through the financial component 214. According to another embodiment, the financial component 214 pays a source of copied information a monetary amount to be able to obtain updates. The financial component 214 can utilize the transmission component 210 in order to engage in financial transactions. For example, the financial component can access debit accounts, credit card accounts, central servers, and the like.

The embed component 102 and the update component 104 operate as disclosed in FIG. 1. In conjunction with the disclosed system 200, the embed component 102 receives copied information from the processor 212. The embed component 102 pastes copied information into an application component 216 which can represent other applications disclosed in the subject specification. For example, the application component 216 can be a visually presented window in a computer operating system and the embed component 102 pastes copied information to the application component 216. The pasted information can be the percentage of computer resources currently used by a computer implementing the system 200. As the resources change, the update component 104 can change the copied information.

According to another embodiment, the pasted information relates to an auxiliary system. The update component 104 utilizes the transmission component 210 to obtain data for updating the information. For example, the pasted information can relate to an estimate time of departure for an airplane flight. The update component 104 uses the transmission component 210 to gather data concerning a flight time change and the update component makes a modification to pasted information of the application component 216.

The presentment component 218 discloses relevant information to a user. According to one embodiment, the application component 216 is a program that involves visual display (e.g., word processing application, operating system, etc.) The presentment component 218 displays application component 216 information that includes pasted information.

According to an aspect, the storage 206 can hold a library of visualizations for information, which can include information so that there is repurpose the data and it maintains the richness it has in its original properties. For instance, a copy-paste of text can be richer if it is known the text represents money or a person's name or other attributes. Moreover, other object can be copy-pasted as well such as pictures, news feeds, etc., any of which can maintain associated properties. In addition, these properties can include more than formatting, but a path back to the original data so that pasted data can be updatable or “live.” As one example, copying data from the web into a document can allow users to create a digital dashboard from a variety of sources. The data in this dashboard can maintain its format and everything else that makes the data interesting wherever it was originally, with preferences that can be selected or inferred about how often the data should be updated from the source. Accordingly, the system 200 can provide the ability to take data from virtually anywhere and repurpose it quickly and conveniently without losing the context or other features present the original representation.

A user can engage the system (e.g., operate a copy-paste function) through a user interface. According to one embodiment, the system 200 operates on a personal electronic device (e.g., cellular telephone, personal digital assistant, etc.) through touching the presentment component 218 with a stylus. According to another embodiment, the system connects with a mouse and keyboard. The user can operate a live copy-paste through utilization of the mouse and/or keyboard.

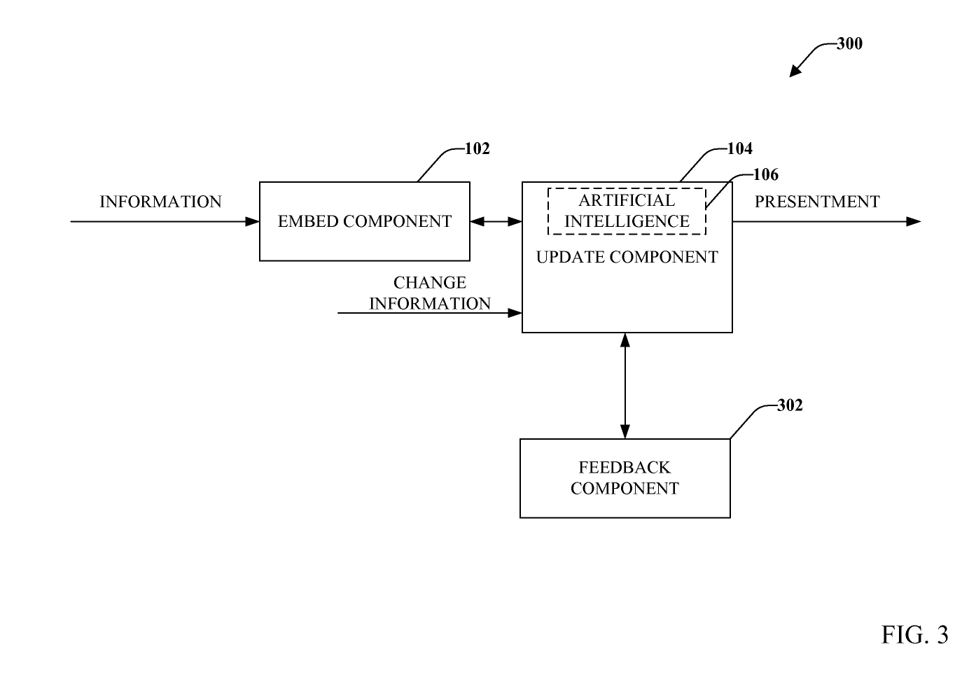

FIG. 3 discloses an example system 300 with a feedback component 302. Information enters into the embed component 102. The embed component 102 pastes the information into an application. An update component 104 modifies information pasted by the embed component 102. Determinations and inferences related to modification can be handled by artificial intelligence 106.

The system 300 can operate in conjunction with a feedback component 302. The feedback component 302 can gather information related to modifying pasted information in relation to a change in a source. For example, the feedback component can perform a check to determine the amount of time there is between a change in the source and a change in the pasted information. The feedback component 302 can store statistics in internal storage or transfer statistics to separate storage, such as the storage 206 of FIG. 2. Furthermore, in addition to determining the time, the feedback component can configure to perform statistical computation. For example, the feedback component can calculate the average amount of time it can take for an update.

According to another embodiment, the feedback component 302 can retain information from a user based on the effectiveness of system 300 operation. The feedback component could present a survey of questions to the user, passively collect statistics concerning a user's operation in conjunction to pasted information (e.g., determine the amount of time between a paste and when pasted information is deleted.), etc. In this embodiment, the feedback component 302 could also make computations based on different gathered statistics.

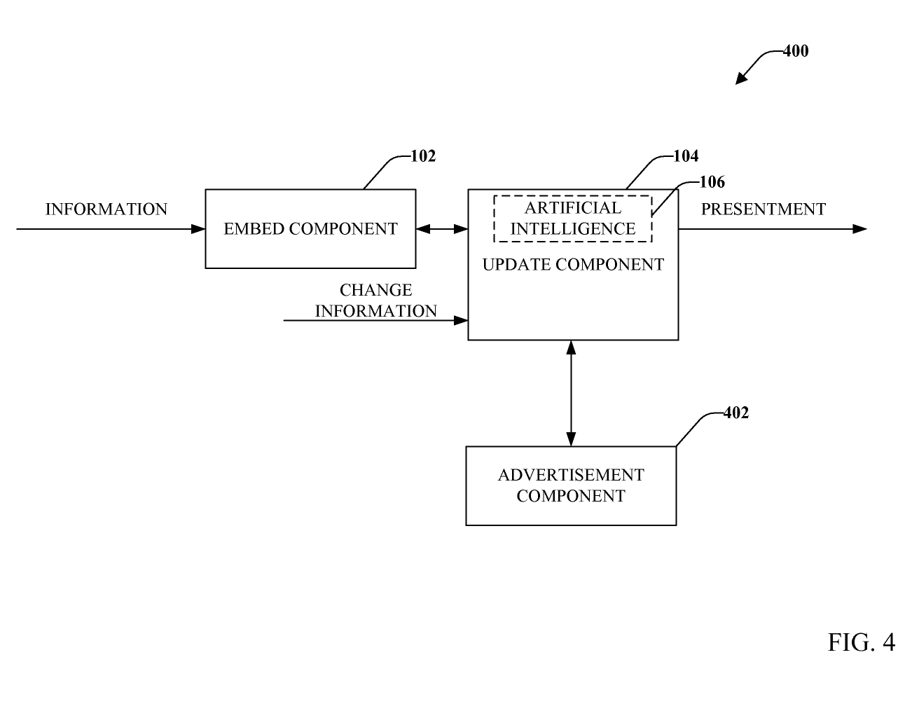

FIG. 4 discloses an example system 400 with an advertisement component 402. Information enters into the embed component 102. The embed component 102 pastes the information into an application. An update component 104 modifies information pasted by the embed component 102. Determinations and inferences related to modification can be handled by artificial intelligence 106.

Pasted information can include both informative information (e.g., stock quote) as well as announcement information (e.g., television show advertisement.) The advertisement component 402 presents announcement information integrated with pasted information. An announcement can include both commercial announcements (e.g., an offer to sell an item for a set price) and non-commercial announcements (e.g., notice of a free concert.)

According to one embodiment, the advertisements component places information next to intended pasted information. For example, if pasted information is a stock quote, then next to the stock quote the advertisement component can place an announcement for the services of a financial adviser. The announcement can be engaged (e.g., clicked with a mouse) and an Internet browser can open with a homepage of the financial adviser.

The update component 104 can change an announcement. For example, advertisers pay a fee for a percentage of announcement time. In this example, five advertisers can pay a fee that their announcements are displayed for 20% of the time (e.g., in a five-minute interval, each advertiser's announcement is presented for one-minute.) The update component 104 can retrieve advertisement information from the advertisement component and change an announcement in accordance with fees paid for announcements.

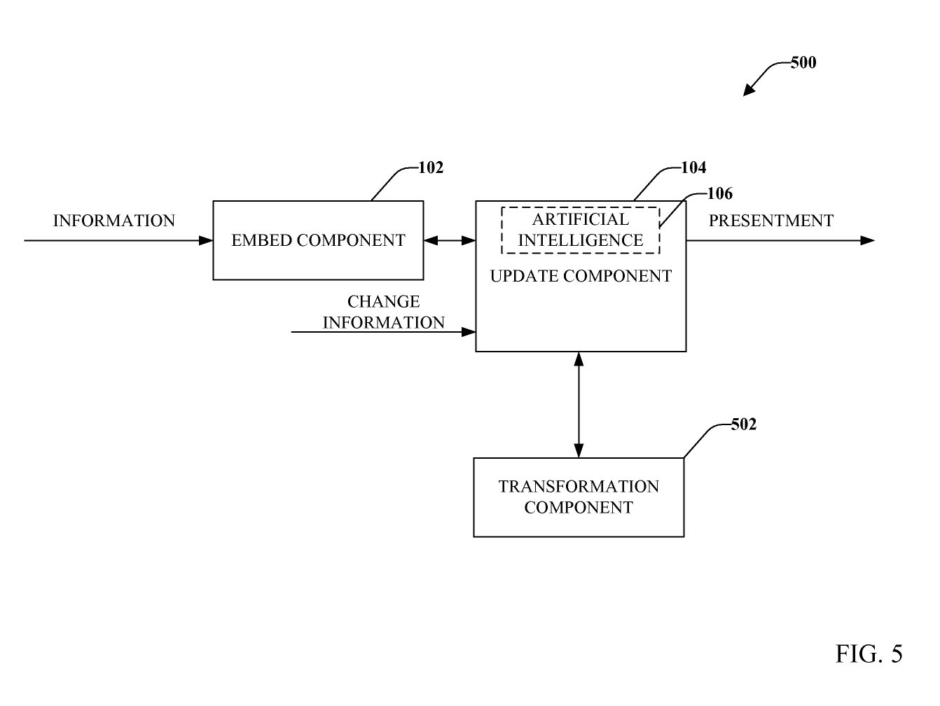

FIG. 5 discloses an example system 500 with a transformation component 502. Information enters into the embed component 102. The embed component 102 pastes the information into an application. An update component 104 modifies information pasted by the embed component 102. Determinations and inferences related to modification can be handled by artificial intelligence 106.

The transformation component 502 modifies information in accordance with the functioning of an application (e.g., the application component 216 of FIG. 2.) For example, a user operating the system 500 can be participating in an online auction. The operator can be located in the United States, yet be bidding on ice hockey memorabilia from Canada. Currency in the United States (e.g., United States Dollar) is different then the currency in Canada (e.g., Canadian Dollar.)

A host for the online auction can be operating in Canada and thus displayed prices are in Canadian currency. It can be difficult for the user to appreciate how much he is paying based on the difference in currency. Therefore, the transformation component 502 can change the information from Canadian currency to United State currency. The update component 102 can make multiple modification types at one time. For example, if the price of hockey memorabilia changes (e.g., there was a higher bidder), then the displayed price can change. In addition, if there is a change in currency ratio (e.g., how much the Canadian Dollar is worth against the United States Dollar), then the transformation component 502 can send an instruction to the update component 102 to change the displayed price based on the currency ratio change. Moreover, the update component can change text information; for example, the name of the current highest bidder.

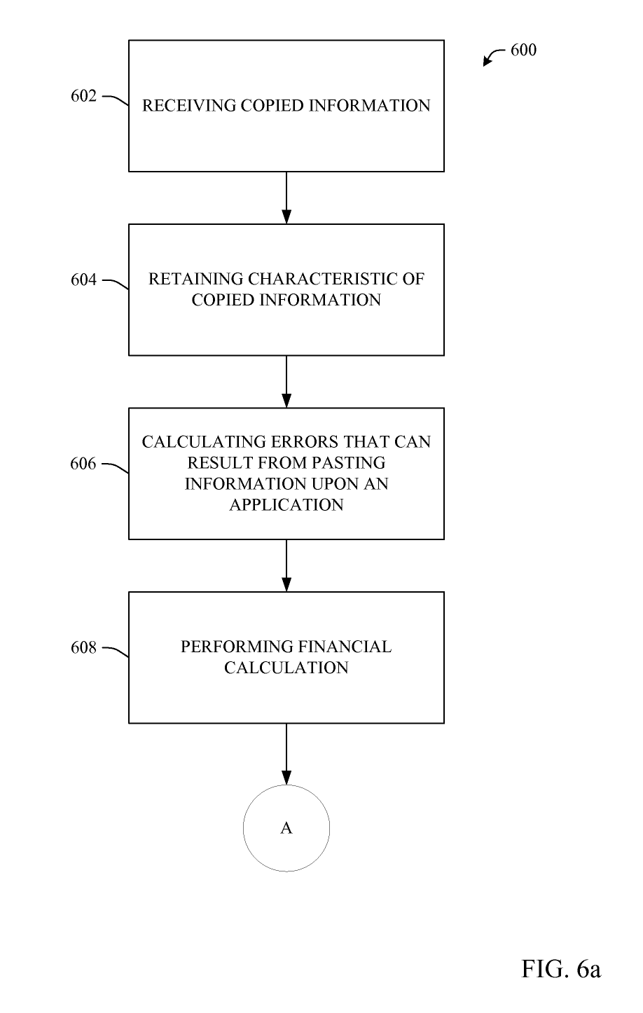

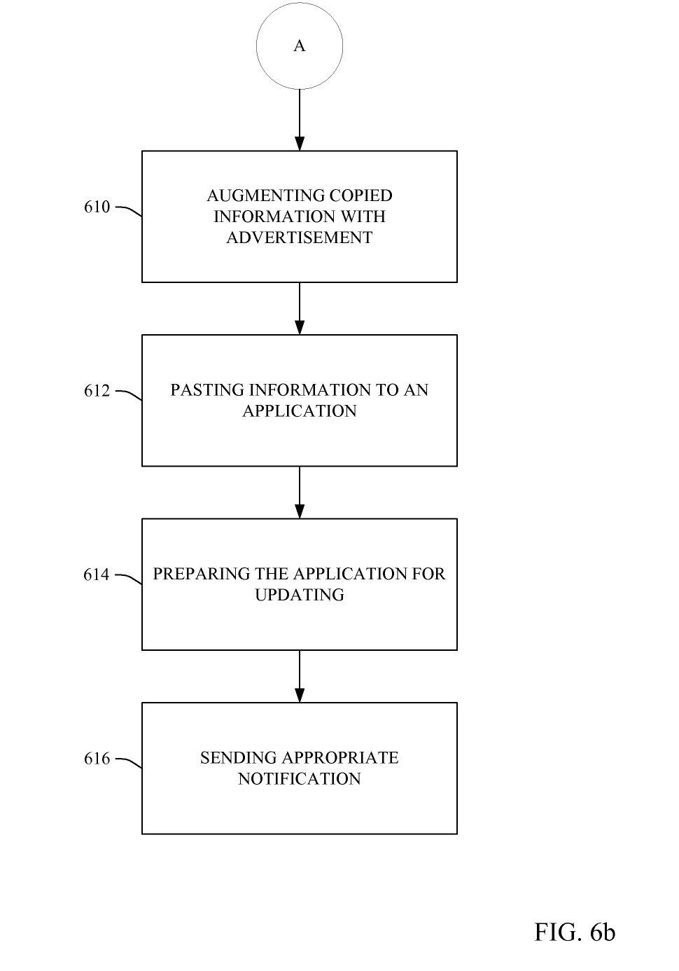

FIG. 6a and FIG. 6b discloses an example methodology 600 for operation of a live copy-paste. The methodology 600 discloses how a system prepares for an update of pasted information. There is receiving of copied information 602. Receiving of copied information can take place through utilization of a reception component 204 of FIG. 2. This can be done through a number of different embodiments, including receiving information from a remote location (e.g., information that originates on a system that does not run the methodology 600) or from a local location (e.g., from within a system running the methodology 600.)

Action 604 is retaining characteristics of copied information. Copied information can have a plurality of different characteristics. The characteristics can range from file size to compression information. This information can be stored for later purposes. For example, if there is a situation where copied information needs to be returned to an original format, then a reference can be made to saved characteristics of copied information.

Calculating errors that can result from pasting information upon an application 606 can take place. It is possible that errors can occur from pasting information into an application. A preliminary check can take place to determine if errors are present. Commonly, this takes place through analyzing the copied information. For example, a comparison can take place between copied information size and the capabilities of a system.

Event 608 is performing financial calculations. There can be financial implications in operating a live copy-paste. For example, is an operator wants to utilize a live copy-paste, a fee is paid each time a live copy-paste is engaged. There can be different fees for information from different sources. Therefore, a calculation can take place determining what amount and/or type of fee should be associated with the live copy-paste. Performing financial calculations can include auxiliary calculations, such as executing a debit on an account (e.g., calculating the amount before and the amount after a debit.)

Augmenting copied information with advertisement 610 can occur. Copied information can have advertisement information added and the advertisement is displayed when information is pasted. Action 610 can work in conjunction with event 608. For example, a fee can be collected for the live copy-paste or an advertisement can be added as part of pasted information.

There can be pasting information to an application 612. This places the copied information as well as auxiliary information (e.g., advertisements) into an application that is viewable by a user. It is not necessary that all copied information be pasted. For example, color information concerning the copied information does not have to be pasted when an application is configured to display information in black and white.

Act 614 can be preparing the application for updating. This can take place according to a number of different embodiments. According to one embodiment, preparing the application is mere completion of a pasting. According to another embodiment, preparation can be sending a signal to an update component that the application is ready to be updated. Yet a further embodiment can include modification of the application (e.g., changing access to the application that allows automatic changes to take place.)

Action 616 can be sending appropriate notification. Appropriate notifications can vary depending on the system operating the methodology 600. For example, a user can receive a notice that pasted information is ready for updating. In another example, a source can be notified that the application is ready to receive update information. It is to be appreciated that there can be configurations where no notice is appropriate, so no notice is sent.

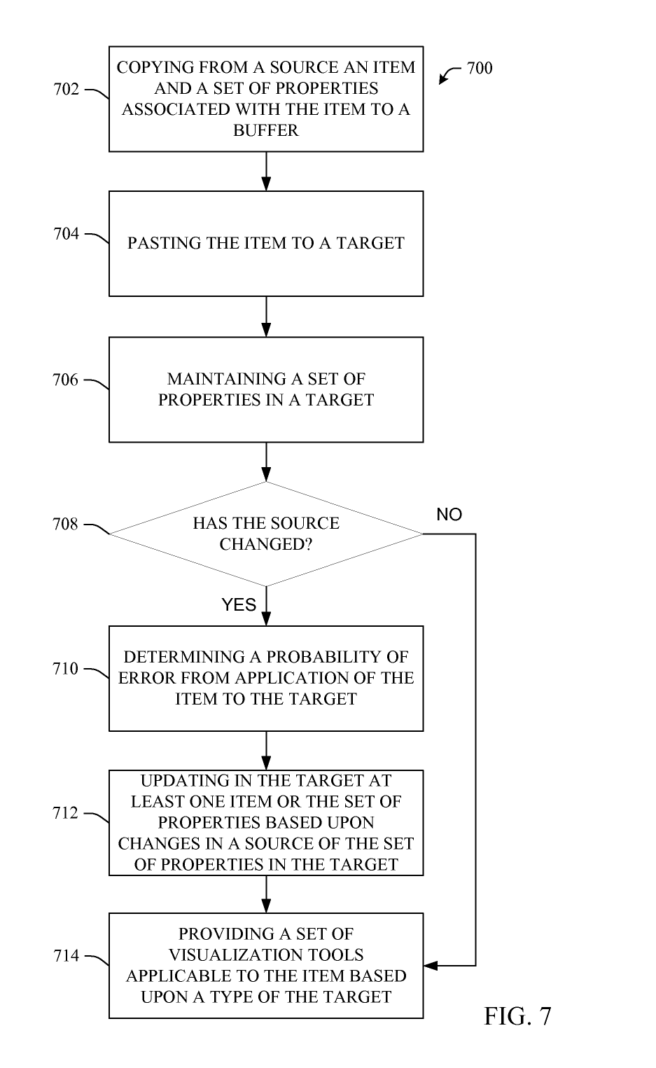

FIG. 7 discloses an example methodology for performance of a live copy-paste. The methodology 700 discloses a general methodology that includes updating pasted information. There can be copying from a source an item and a set of properties associated with the item to a buffer 702. A source can be a number of different locations, including a web page, a word processing document, a photograph album, etc. Copying commonly involves creating an information set that allows for exact duplication of the item. For example, in copying a digital image, there can be a creation of a separate file with information that can allow a component to create a replica of the digital image. The set of properties can include a path to the source. The path to the source can be an Internet address that can be engaged to reach the source.

In addition to the copying of the image, there can be various properties copied that relate to the item. For example, an image can have hue properties, dimension properties, resolution properties, etc. Act 702 retains the information that can be used at a later time. The item and the set of properties can transfer to a buffer. Commonly a buffer is a location that can temporarily hold information. For example, information can transfer from a spreadsheet to a buffer and then from the buffer to a word-processing document for pasting. A set of properties is one or more properties. Furthermore, a property can be a portion of a property or a whole property (e.g., a property of ‘black or white’ is a portion of a ‘color’ property.)

Action 704 is pasting the item to a target. Pasting commonly is placing an exact or near exact replica of copied information to target. For example, a user can copy information from text and then paste the information onto a document through use of a computer interface (e.g., through a mouse and a screen of a personal computer.) According to one embodiment, information is pasted exactly as it appeared at the source. According to another embodiment, copied information is pasted as a close proximity to source information. For example, the copied text is in a font style that cannot be supported by a target application. Therefore, modification is done to the text to allow it to be presented in the target application.

Maintaining a set of properties in a target 706 can take place. A target can have a specific format that should be followed. For example, a word processing document can be in Times New Roman font, while copied information is in Arial font. To keep uniformity in a document, pasted information should conform to the format of the target. Therefore, pasted information as well as updated information can have the same properties as the target.

Event 708 is checking if the source has changed. The source of pasted information can change for a variety of reasons. For example, the source of the information could be a news service that posts new messages periodically. In order to update information, it can be beneficial to determine when a source has changed. Checking can be a passive action (e.g., the news service sends data that an update has taken place as well as the update) or an active action (e.g., searching to determine if an update has take place.)

There can be determining probability of error from application of the item to the target 710. Pasting of some information can cause a system error. For example, if copied information is larger then allocated memory at the target, then pasting the copied information would become problematic (e.g., only some information would be displayed, an error message would display, there would be a system crash, etc.) In some cases, there would be a 100% probability or there would be 0% probability of error. However, there are also cases where error probability would be between the two extremes. In addition, the methodology 700 can include an action of stopping the methodology 700 if there was a probability of error over a certain threshold (e.g., more then 5%, then do not update).

Updating in the target at least one item or the set of properties based upon changes in a source of the set of properties in the target 712 can take place. If information changes at the source, then event 712 allows the change to be duplicated in what is presented at the target. This can take place according to a number of different embodiments. According to one embodiment, there can be a save made of updates and a user of an application holding the target can have access to information that has subsequently changed. According to another embodiment, received information is placed into the target.

Act 714 is providing a set of visualization tools applicable to the item based upon a type of the target. Visualization tools can be applicable regardless of an outcome for the check 808. The tools can allow for the recapture of data after it has been pasted. For example, if there were to be re-copying of data from the target, a provided tool could be engaged to copy information as it was at the source (e.g., information retains font style regardless of capabilities of the target.)

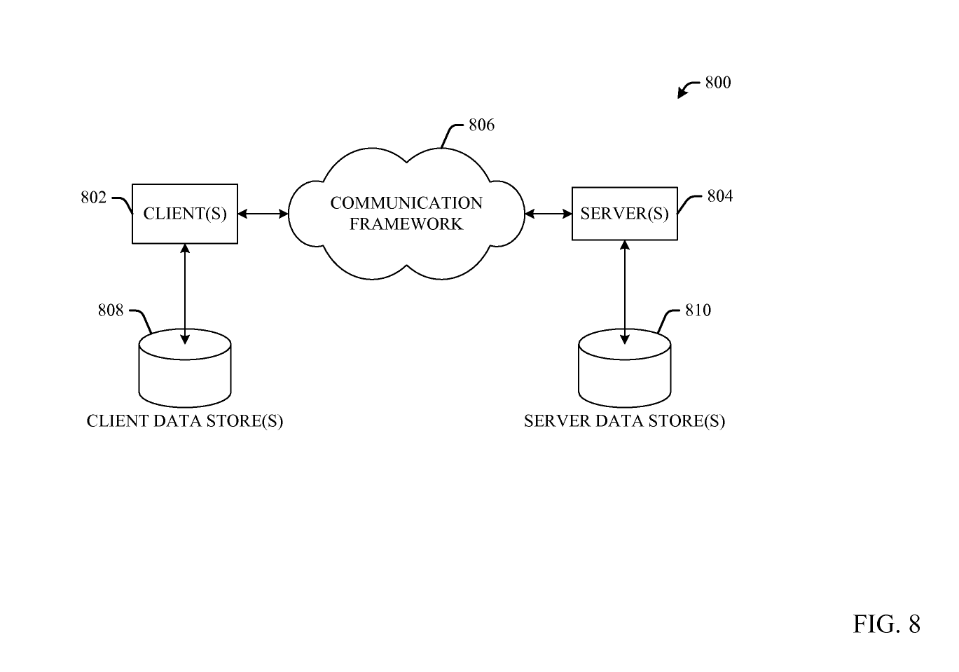

Referring now to FIG. 8, there is illustrated a schematic block diagram of a computing environment 800 in accordance with the subject specification. The system 800 includes one or more client(s) 802. The client(s) 802 can be hardware and/or software (e.g., threads, processes, computing devices). The client(s) 802 can house cookie(s) and/or associated contextual information by employing the specification, for example.

The system 800 also includes one or more server(s) 804. The server(s) 804 can also be hardware and/or software (e.g., threads, processes, computing devices). The servers 804 can house threads to perform transformations by employing the specification, for example. One possible communication between a client 802 and a server 804 can be in the form of a data packet adapted to be transmitted between two or more computer processes. The data packet may include a cookie and/or associated contextual information, for example. The system 800 includes a communication framework 806 (e.g., a global communication network such as the Internet) that can be employed to facilitate communications between the client(s) 802 and the server(s) 804.

Communications can be facilitated via a wired (including optical fiber) and/or wireless technology. The client(s) 802 are operatively connected to one or more client data store(s) 808 that can be employed to store information local to the client(s) 802 (e.g., cookie(s) and/or associated contextual information). Similarly, the server(s) 804 are operatively connected to one or more server data store(s) 810 that can be employed to store information local to the servers 804.

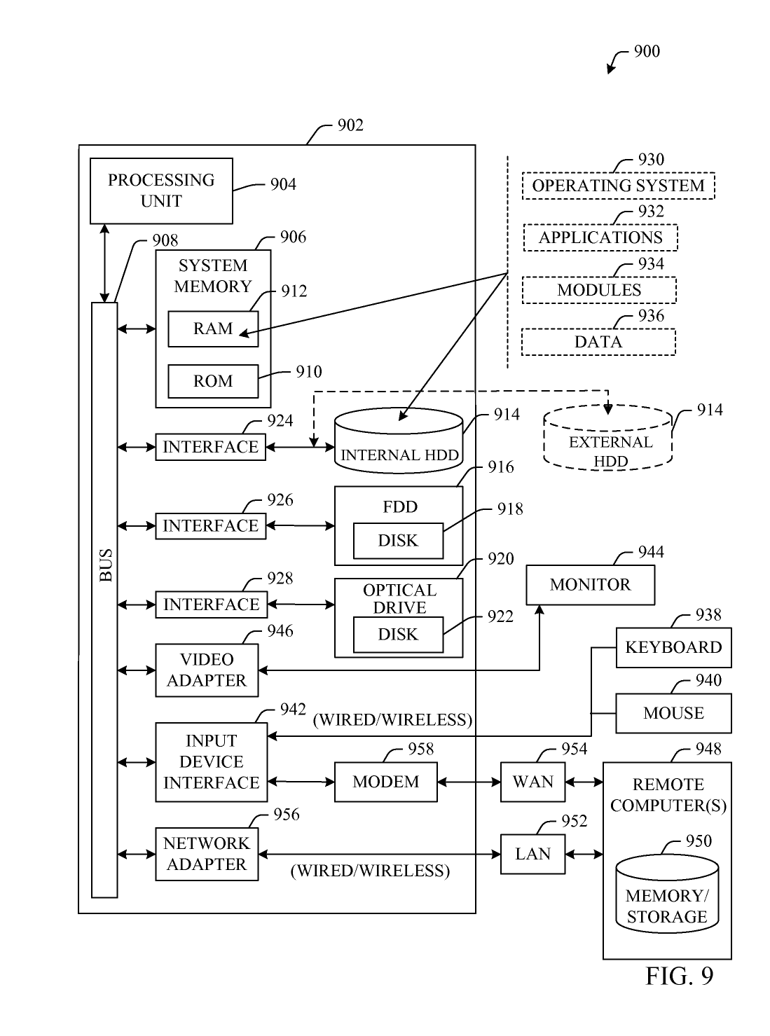

Referring now to FIG. 9, there is illustrated a block diagram of a computer operable to execute the disclosed architecture. In order to provide additional context for various aspects of the subject specification, FIG. 9 and the following discussion are intended to provide a brief, general description of a suitable computing environment 900 in which the various aspects of the specification can be implemented. While the specification has been described above in the general context of computer-executable instructions that may run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the example environment 900 for implementing various aspects of the specification includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the example operating environment, and further, that any such media may contain computer-executable instructions for performing the methods of the specification.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the specification can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 1394 serial port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers, etc.

The computer 902 may operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g., the Internet.

When used in a LAN networking environment, the computer 902 is connected to the local network 952 through a wired and/or wireless communication network interface or adapter 956. The adapter 956 may facilitate wired or wireless communication to the LAN 952, which may also include a wireless access point disposed thereon for communicating with the wireless adapter 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are example and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
an embed component that pastes information copied from an auxiliary source; and
an update component that changes pasted information based on a related change of the auxiliary source.

2. The system of claim 1, further comprising a reception component that obtains information that concerns the related change of the auxiliary source.

3. The system of claim 1, further comprising a retention component that extracts contextual data from the information.

4. The system of claim 1, further comprising a transformation component that modifies pasted information with application context.

5. The system of claim 1, further comprising a scan component that determines possible errors that could occur from paste of information copied from the auxiliary source.

6. The system of claim 1, further comprising a presentment component that produces changed pasted information.

7. The system of claim 1, further comprising a financial component that associates a fee with changed pasted information.

8. The system of claim 1, further comprising an application component that holds pasted information when a change to the information takes place.

9. The system of claim 1, wherein the update component operates automatically.

10. The system of claim 1, further comprising artificial intelligence that makes an inference or determination if a change by the update component would be detrimental.

11. The system of claim 1, further comprising a feedback component that obtains data related to changed pasted information.

12. The system of claim 1, further comprising an advertisement component that places an announcement in conjunction with changed pasted information.

13. A computer-implemented method for facilitating live representations of data, comprising:
maintaining a set of properties in a target; and
updating in the target at least one item or the set of properties based upon changes in a source of the set of properties in the target.

14. The method of claim 13, further comprising copying from a source an item and a set of properties associated with the item to a buffer.

15. The method of claim 13, further comprising pasting the item to a target.

16. The method of claim 13, further comprising providing a set of visualization tools applicable to the item based upon a type of the target.

17. The method of claim 13, further comprising checking if the source has changed.

18. The method of claim 13, further comprising determining probability of error from application of the item to the target.

19. The method of claim 13, wherein the set of properties includes a path to the source.

20. A system, comprising:
means for maintaining a set of properties in a target; and
means for updating in the target at least one item or the set of properties based upon changes in a source of the set of properties in the target.
